(19) United States
(12) Patent Application Publication
(10) Pub. No.: US 2015/0377359 A1
(43) Pub. Date: Dec. 31, 2015

(54) MECHANICAL SEAL CONTROL APPARATUS

(71) Applicant: Carl-Eiler Rodrigues, Rotherham (GB)

(72) Inventor: Carl-Eiler Rodrigues, Rotherham (GB)

(73) Assignee: AES ENGINEERING LTD., Rotherham (GB)

(21) Appl. No.: 14/743,031

(22) Filed: Jun. 18, 2015

(30) Foreign Application Priority Data
Jun. 26, 2014 (GB) 1411427.6

(51) Int. Cl. F16J 15/34

(52) U.S. Cl. CPC F16J 15/346; F16J 15/3452; F16J 15/3496

(57) ABSTRACT

A mechanical seal control apparatus includes a thermally responsive element for reducing or negating face contact pressure upon at least one seal face of a mechanical seal when heat is generated within the mechanical seal above a pre-determined temperature. The thermally responsive element preferably includes, or is, a shape-memory material sensitive to thermal changes to increase or decrease in size, or change in shape, when subjected to changes of temperature of the mechanical seal and is, preferably, a bimetal, such as, for example, nitinol. Upon cooling of the mechanical seal, the shape-memory material substantially, or entirety, reverts to its original size or original shape to increase the face contact pressure for retaining the integrity of the mechanical seal.

### BACKGROUND OF THE INVENTION

1. Field of Invention

The present invention relates, generally, to a mechanical seal control apparatus and, more particularly, to the use of a “smart material” with the ability to convert temperature change into a reduction in face contact pressure within a mechanical seal in the undesired operating condition commonly referred to as “dry running.”

2. Description of the Prior Art

A mechanical seal generally comprises a rotating member attached to the pump shaft and a stationary member attached to the pump housing. The rotating member is in relative contact with the stationary member, which provides the seal. Both the rotating member and the stationary member are commonly referred to in the mechanical sealing industry as seal “faces.” A basic operating principle of mechanical seals is that the seal faces require a “fluid film” that provides a lubricant between the seal faces in order to function correctly.

The operating condition of “dry running” occurs between the seal faces when a “fluid film” is not present to lubricate them. This results in the faces being in direct contact while in operation and thus generating heat. This heat can cause the faces to wear and the contacting elastomers to distort and melt, in turn, causing the mechanical seal to fail.

Reducing face contact pressure or friction between the rotary and stationary faces during periods of dry running can reduce heat generation, face wear and elastomer damage.

Current solutions include:

(a) Polycrystalline diamond coatings adhered to the faces with the aim to reduce face contact wear by increasing hardness;

(b) Amorphous diamond-like coatings adhered to the faces with the aim to reduce face temperature through decreased friction; and,

(c) Dual seals providing a “stable” lubrication from a dedicated system which do not rely on the process fluid, however these dual seals can still falter through the system fluid finishing or if the system is inadvertently shut off.

Problems still exist with the foregoing known solutions including cost, reliability and application limitations.

### SUMMARY OF THE INVENTION

It is, therefore, an object of the present invention to provide a mechanical seal control apparatus that can reduce face contact pressure within a mechanical seal in the undesired operating condition commonly referred to as “dry running.”

The foregoing and related objects are accomplished by the present invention for a mechanical seal control apparatus, in which the face contact pressure caused by the spring pressure is negated by the force produced when the thermally activated “smart material” shape is altered. A “smart material,” as to be understood in the instant disclosure, is intended to be a shape-memory material that is sensitive to thermal changes such that it increases or decreases in size and/or shape when subjected to a change in temperature. The so-called “smart material,” as referred in this disclosure, may comprise a bimetal, a shape memory alloy (e.g., nickel titanium or nitinol, which is a metal alloy of nickel and titanium) or a shape memory polymer. Additionally, the smart material may comprise combinations of one or more those items.

More particularly, the “smart material” is intended to be a shape-memory material that is sensitive to thermal changes such that it increases or decreases in size and/or shape when subjected to a change in temperature. Preferably, the change is a two-way change, although it may be desirable to employ a one-way shape-change material in certain circumstances. The advantage of a two-way change is that where the material has changed shape upon heating to reduce the face contact pressure, upon the system cooling, the pressure can be increased to retain the integrity of the seal.

A problem is addressed by distinguishing the condition of dry running from normal operating conditions and implementing a mechanical system able to reduce or eliminate face pressure through separation of the faces. An advantage of using a smart material to address this problem is that it can be incorporated into an element of the seal mechanism and so have a direct effect on the seal faces. Additionally, it may be possible to retrofit such parts into existing seal mechanisms.

Additionally, when utilizing a bimetal or shape memory alloy it can be used within seals operating at differing temperatures by specifying the material to alter shape at the appropriate temperature. This provides an advantage in that the system can be operated at predetermined temperatures to provide a predetermined thermal response.

Other objects and features of the present invention will become apparent when considered in combination with the accompanying drawing figures, which illustrate certain preferred embodiments of the present invention. It should, however, be noted that the accompanying drawing figures are intended to illustrate only select preferred embodiments of the claimed invention and are not intended as a means for defining the limits and scope of the invention.

### BRIEF DESCRIPTION OF THE DRAWING FIGURES

In the drawing, wherein similar reference numerals and symbols denote similar features throughout the several views:

FIG. 1 shows a cross-sectional side view profile of a typical mechanical seal;

FIG. 2 shows an enlarged cross-sectional side view profile of a typical mechanical seal in operational conditions using the first embodiment of a bimetal;

FIG. 3 shows an enlarged cross-sectional side view profile of a typical mechanical seal in dry running conditions using the first embodiment of a bimetal;

FIG. 4 shows an enlarged cross-sectional side view profile of a typical mechanical seal in operational conditions using the second embodiment of a bimetal;

FIG. 5 shows an enlarged cross-sectional side view profile of a typical mechanical seal in dry running conditions using the second embodiment of a bimetal;

FIG. 6 shows an enlarged cross-sectional side view profile of a typical mechanical seal in operational conditions using a smart memory alloy spring; and,

FIG. 7 shows an enlarged cross-sectional side view profile of a typical mechanical seal in dry running conditions using a smart memory alloy spring.

### DETAILED DESCRIPTION OF THE DRAWING FIGURES AND PREFERRED EMBODIMENTS

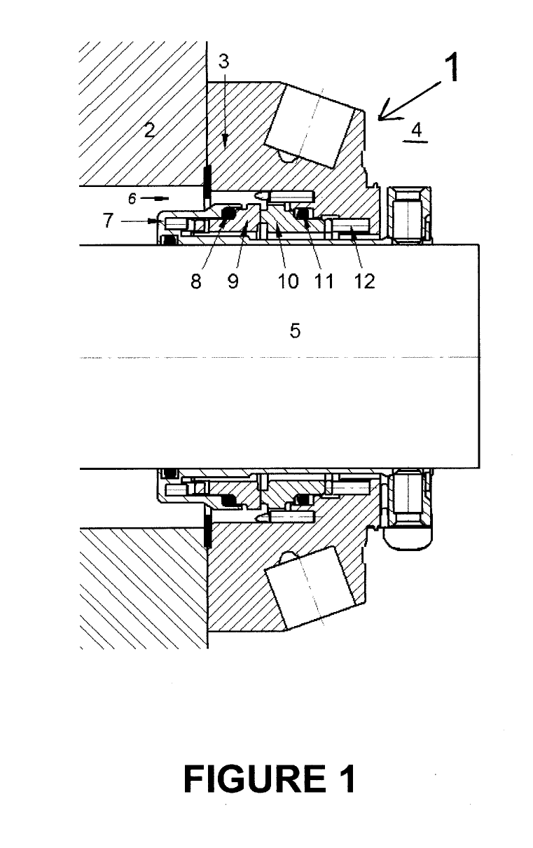

Turning, in detail, to an analysis of the accompanying drawing figures, FIG. 1 shows a cross-sectional side view profile of a typical mechanical seal 1, that comprises a pump housing 2 and a longitudinally non-floating member, the gland 3, which is fixed to said pump housing, the surrounding atmosphere 4, a shaft 5, which axially aligns with the gland, a process fluid 6 contained within the pump housing, a longitudinally floating second member, the shaft sleeve 7, which attaches axially to the shaft, an elastomeric sealing member, a rotary O-ring 8, a longitudinally floating seal face, the rotary 9, a longitudinally non-floating seal face, the stationary 10, a secondary elastomeric sealing member, a stationary O-ring 11, and spring biasing means 12. In operation, the stationary floating seal face 10 is energized by the spring 12 thereby causing the seal face 9 to contact the stationary seal face 10. Between the seal faces 9, 10 a fluid film of lubrication is provided by the process fluid being pumped 6.

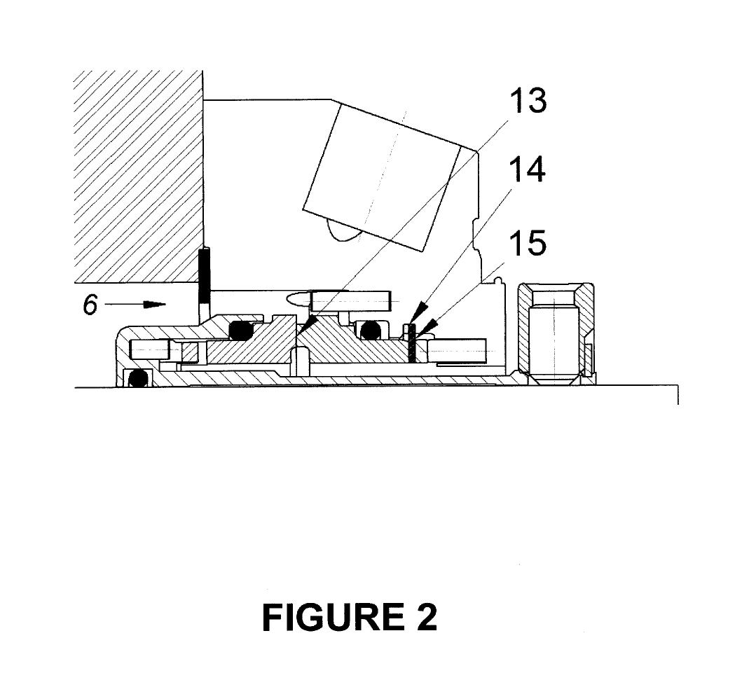

FIG. 2 shows an enlarged cross-sectional side view profile of a typical mechanical seal in operational conditions with fluid 6, present between the faces 13, illustrating the first preferred embodiment of the present invention using a bimetal 14 and circlip 15 in normal operational conditions.

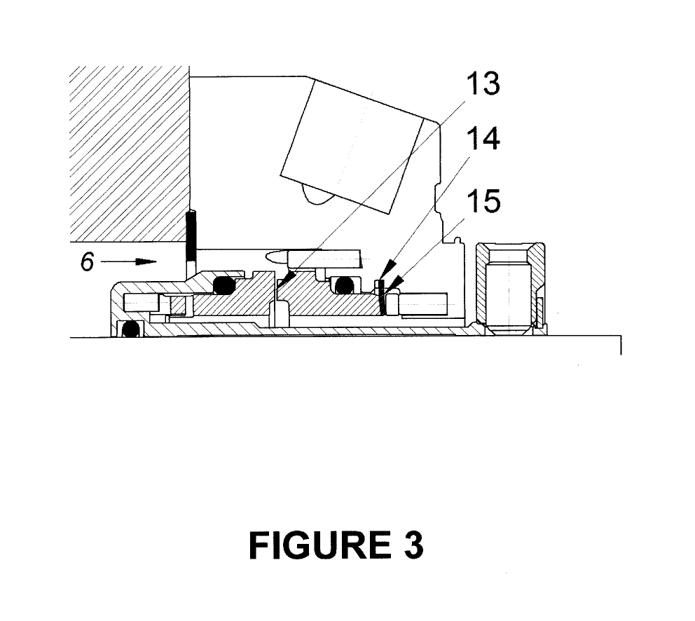

FIG. 3 shows an enlarged cross-sectional side view profile of a typical mechanical seal in dry running conditions with no fluid 6 present between the faces 13, causing an initial direct contact. FIG. 3 shows the preferred first embodiment of the present invention using a bimetal 14 and circlip 15 to fit the bimetal. In this condition, a reduction in pressure between the seal faces is obtained by negating the spring biasing means through deflection of the disc acting on the stationary seal face, moving the faces away from each other. When faces reach a predetermined temperature, the bimetal deflects. When the faces return to predetermined temperature, the bimetal returns to its original shape.

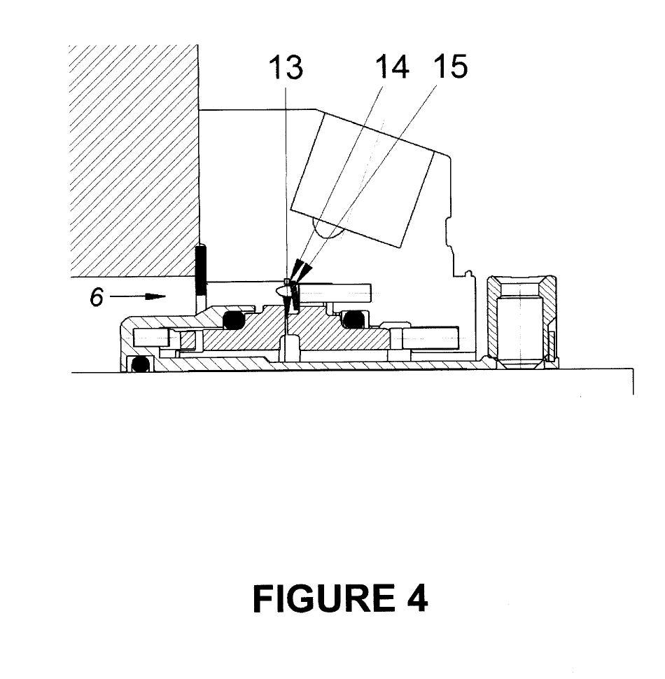

FIG. 4 shows an enlarged cross-sectional side view profile of a typical mechanical seal in operational conditions with fluid 6 present between the faces 13. FIG. 4 shows the preferred second embodiment of the present invention having a bimetal 15, altering the location within the seal, acting directly on the face forcing a gap between them.

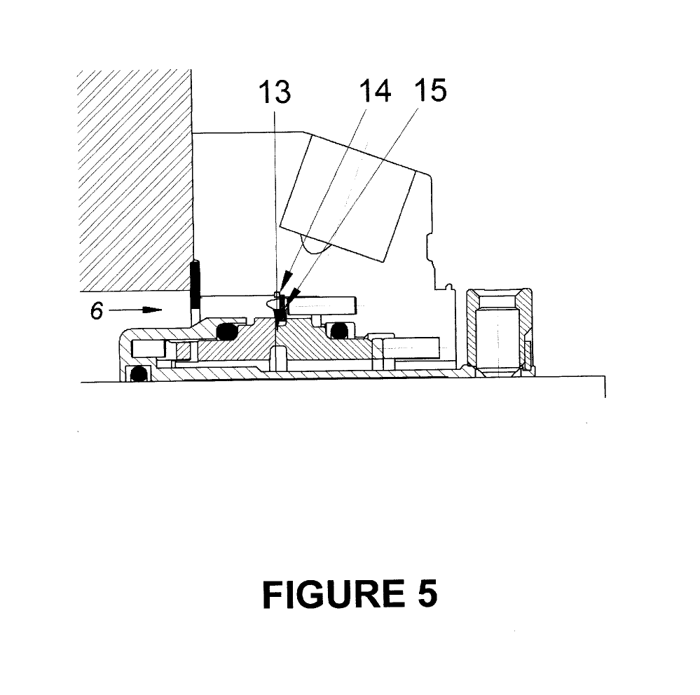

FIG. 5 shows an enlarged cross-sectional side view profile of a typical mechanical seal in dry running conditions with no fluid 6 present between the faces 13, causing an initial direct contact. This drawing figure illustrates the preferred second embodiment of the present invention utilizing a bimetal 15; the alternative location offers a faster response to temperature changes.

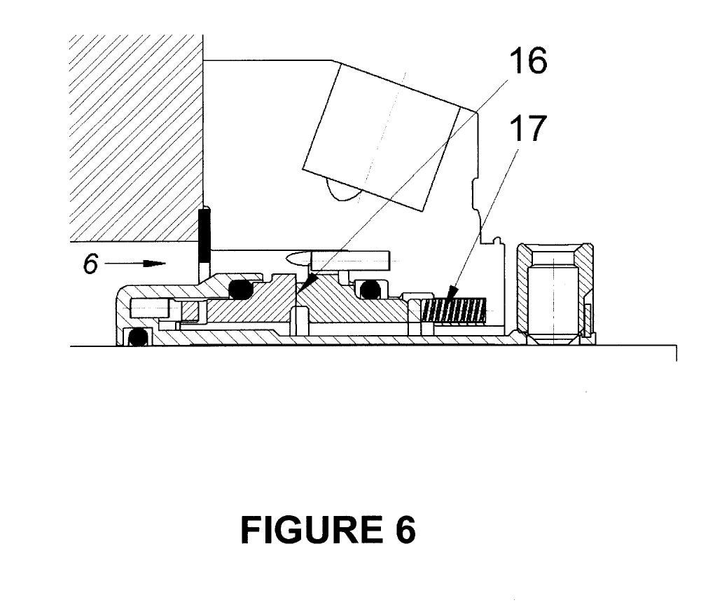

FIG. 6 shows an enlarged cross-sectional side view profile of a typical mechanical seal in operational conditions with fluid 6 and illustrating the third preferred embodiment using a “smart” memory alloy spring 17 in normal operational conditions.

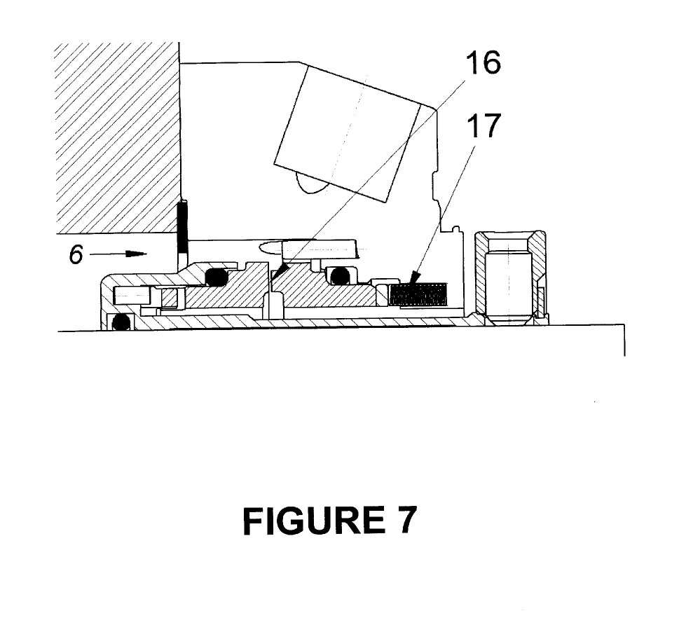

FIG. 7 shows an enlarged cross-sectional side view profile of a typical mechanical seal in dry running conditions with no fluid 6 present between the faces 16, causing an initial direct contact. FIG. 7 shows the third preferred embodiment of the present invention utilizing a “smart” memory alloy spring 17 in dry running operation conditions where heat is present. A reduction in face pressure is initiated through the heat transfer to the back face and into the spring 17. Upon heating the spring contracts, opening the faces 16, and when temperature is normalized, the spring extends to normal working lengths.

While only several embodiments of the present invention have been shown and described, it will be obvious to those skilled in the art that many modifications may be made to the present invention without departing from the spirit and scope thereof.

What is claimed is:

1. A mechanical seal, comprising:
biasing means;
at least one seal face under axial contact via said biasing means; and,
a thermally responsive element for reducing or negating face contact pressure upon said at least one seal face when heat is generated within said mechanical seal above a pre-determined temperature.

2. The mechanical seal according claim 1, wherein said biasing means is a spring biasing means.

3. The mechanical seal according to claim 1, wherein said thermally responsive element comprises a shape-memory material sensitive to thermal changes to increase or decrease in size when subjected to a change in temperature.

4. The mechanical seal according to claim 1, wherein said thermally responsive element comprises a shape-memory material sensitive to thermal changes for causing said shape-memory material to change shape.

5. The mechanical seal according to claim 1, wherein said thermally responsive element comprises a bimetal.

6. The mechanical seal according to claim 5, wherein said bimetal is nitinol.

7. The mechanical seal according to claim 1, wherein said pre-determined temperature correlates with a maximum operating temperature of contacting elastomers of said mechanical seal.

8. The mechanical seal according to claim 1, wherein said at least one seal face includes a floating seal face and a non-floating seal face with heat being generated via contact between said floating seal face and said non-floating seal face for initiating a response by said thermally responsive element.

9. The mechanical seal according to claim 1, wherein said thermally responsive element comprises a shape-memory material sensitive to thermal changes to increase or decrease in size, or to change shape, when subjected to a change in temperature of said mechanical seal for reducing or negating the face contact pressure and, upon cooling of said mechanical seal, said shape-memory material substantially reverts to its original size or original shape to increase the face contact pressure for retaining integrity of said mechanical seal.

10. A mechanical seal control apparatus, comprising:
a thermally responsive element for reducing or negating face contact pressure upon at least one seal face of a mechanical seal when heat is generated within the mechanical seal above a pre-determined temperature.

11. The mechanical seal control apparatus according to claim 10, wherein said thermally responsive element comprises a shape-memory material sensitive to thermal changes to increase or decrease in size when subjected to a change in temperature.

12. The mechanical seal control apparatus according to claim 10, wherein said thermally responsive element comprises a shape-memory material sensitive to thermal changes for causing said shape-memory material to change shape.

13. The mechanical seal control apparatus according to claim 10, wherein said thermally responsive element comprises a bimetal.

14. The mechanical seal control apparatus according to claim 13, wherein said bimetal is nitinol.

15. The mechanical seal control apparatus according to claim 10, wherein said thermally responsive element comprises a shape-memory material sensitive to thermal changes to increase or decrease in size, or to change shape, when subjected to a change in temperature of a mechanical seal for reducing or negating the face contact pressure and, upon cooling of the mechanical seal, said shape-memory material substantially reverts to its original size or original shape to increase the face contact pressure for retaining integrity of the mechanical seal.
